(19) United States
(12) Patent Application Publication
(10) Pub. No.: US 2003/0192599 A1
(43) Pub. Date: Oct. 16, 2003

(54) Fuel pump apparatus

(76) Inventor: Akira Aoyama, Obu-shi (JP)

Correspondence Address: BAKER & BOTTS, 30 ROCKEFELLER PLAZA, NEW YORK, NY, 10112

(21) Appl. No.: 10/411,782

(22) Filed: Apr. 11, 2003

(30) Foreign Application Priority Data
Apr. 12, 2002 (JP) 2002-146975

(51) Int. Cl. G01F 23/30; F16K 31/02; B67D 5/08

(52) U.S. Cl. 137/565.16; 73/309

(57) ABSTRACT

A fuel pump apparatus is made free from the influence of height fluctuations of the surface of fuel in a fuel tank by providing a fuel inlet window in the side wall of a float chamber for containing a fuel gauge, which is provided inside the side wall of a housing. The fuel inlet window provides communication between the float chamber and the fuel storage chamber in the fuel tank. Even when there are height fluctuations of the surface of fuel in the fuel tank due to vibrations or turning during running of the automobile, the height fluctuations of the fuel surface are damped in the float chamber because the fuel inlet window acts as a buffer to prevent direct influence of the height fluctuations of the fuel surface.

### BACKGROUND OF THE INVENTION

1. Field of the Invention

The present invention relates to a fuel pump apparatus for use in an automobile or the like. More particularly, the present invention relates to a fuel pump apparatus in which a fuel pump integrated with a fuel gauge is installed in a fuel tank.

2. Discussion of Related Art

There has heretofore been known a fuel pump apparatus wherein a fuel pump integrated with a fuel gauge is disposed in a fuel tank, whereby the amount of fuel remaining in the tank is detected with the fuel gauge, and the fuel is discharged by the fuel pump and supplied to the associated engine. Incidentally, the fuel gauge needs to indicate the amount of remaining fuel accurately at all times regardless of height fluctuations of the fuel surface due to vibrations or turning during running of the automobile.

Accordingly, a fuel pump apparatus disclosed in Japanese Patent Application Unexamined Publication (KOKAI) No. Hei 9-126080 (also referred to as “conventional system 1”) has a Hall element 34 inserted in a housing 21. A permanent magnet 35 is disposed facing the Hall element 34. The permanent magnet 35 is movable toward and away from the Hall element 34. A spring 36 is disposed between the Hall element 34 and the permanent magnet 35. A float 37 is slidably installed at the lower end portion of the housing 21. One end of the float 37 is engaged with the permanent magnet 35. The lower end of the float 37 is exposed below the surface of fuel 6 (see FIG. 1). The Hall element 34, the permanent magnet 35, the spring 36 and the float 37 constitute in combination a fuel gauge. The float 37 moves up and down with the displacement of the surface of fuel 6, and the permanent magnet 35 moves toward or away from the Hall element 34 in response to the vertical movement of the float 37. Accordingly, magnetic force acting on the Hall element 34 changes, resulting in a change in the output voltage.

Japanese Patent Application Unexamined Publication (KOKAI) No. 2001-152994 (also referred to as “conventional system 2”) discloses an arrangement in which a float 51 is vertically movably fitted in a sender gauge 50, and a large number of magnetoresistive elements 52 are provided to sense vertical movement of the float 51. The amount of fuel in the fuel tank is detected by sensing the vertical movement of the float 51 through the magnetoresistive elements 52.

### SUMMARY OF THE INVENTION

In the conventional fuel pump apparatus (conventional system 1), the lower end of the float 37 is exposed below the surface of fuel 6, and the float 37 moves up and down with the change in height of the fuel surface. Therefore, the magnitude of buoyancy force acting on the float 37 changes at all times in response to height fluctuations of the fuel surface due to vibrations or turning during running of the automobile. Accordingly, it is difficult to indicate the amount of remaining fuel accurately.

In the conventional fuel supply apparatus (conventional system 2), the float 51 is small in size and moves up and down with the change in height of the fuel surface. Therefore, the position at which the float 37 is floating changes at all times in response to height fluctuations of the fuel surface due to vibrations or turning during running of the automobile. Accordingly, it is difficult to indicate the amount of remaining fuel accurately.

The present invention was made to solve the above-described problems. Accordingly, an object of the present invention is to provide a fuel pump apparatus made free from the influence of height fluctuations of the fuel surface by providing a fuel inlet window in the side wall of a float chamber in a housing.

To attain the above-described object, according to a first aspect of the present invention, there is provided a fuel pump apparatus wherein a fuel pump and a fuel gauge are formed in an integral structure, and a fuel inlet window is provided in the side wall of a float chamber to provide communication between the float chamber and a fuel storage chamber in a fuel tank.

According to the present invention, even when there are height fluctuations of the surface of fuel in the fuel tank due to vibrations or turning during running of the automobile, the height fluctuations of the fuel surface are damped in the float chamber because the fuel inlet window acts as a buffer to prevent direct influence of the height fluctuations of the fuel surface.

According to a second aspect of the present invention, the fuel pump apparatus is provided with a fuel level detecting element that shows a change in voltage according to the magnitude of buoyancy force acting on the float substantially immovably disposed in the float chamber. Therefore, the float itself does not swing up and down even when there are height fluctuations of the fuel surface due to vibrations or turning during running of the automobile. Accordingly, the influence of height fluctuations of the fuel surface can be minimized.

According to a third aspect of the present invention, the fuel pump apparatus is provided with a fuel level detecting element that shows a change in resistance according to the displacement of a float disposed in the float chamber in such a manner as to be capable of displacement according to the height of the fuel surface. Therefore, the float itself does not greatly swing up and down even when there are height fluctuations of the fuel surface due to vibrations or turning during running of the automobile. Accordingly, the influence of height fluctuations of the fuel surface can be reduced.

According to a fourth aspect of the present invention, the fuel inlet window is provided in a lattice configuration. With this arrangement, the liquid fuel comes in and out through the lattice-shaped fuel inlet window. Therefore, height fluctuations of the fuel surface are damped even more effectively.

According to a fifth aspect of the present invention, the float is provided with a plurality of through-holes. With this arrangement, the liquid fuel flows through the through-holes. Therefore, height fluctuations of the fuel surface are damped. Further, the liquid fuel flowing through the through-holes suppresses the vertical swing of the float.

According to a sixth aspect of the present invention, the float comprises an upper float member and a lower float member. The sectional area of the lower float member is made larger than that of the upper float member to increase the magnitude of buoyancy force acting on the float. Therefore, the influence of the fuel surface height fluctuations can be further reduced. In addition, even when the amount of fuel remaining in the fuel tank is small, the required buoyancy force is available.

Thus, according to the first aspect of the present invention, a fuel inlet window is provided in the wall surface of the float chamber. Therefore, the amount of remaining fuel can be stably indicated even when there are height fluctuations of the fuel surface due to vibrations or turning during running of the automobile.

According to the second aspect of the present invention, the fuel pump apparatus is provided with a fuel level detecting element that shows a change in voltage according to the magnitude of buoyancy force acting on the float substantially immovably disposed in the float chamber. Therefore, the amount of remaining fuel can be stably indicated even when there are height fluctuations of the fuel surface due to vibrations or turning during running of the automobile.

According to the third aspect of the present invention, the fuel pump apparatus is provided with a fuel level detecting element that shows a change in resistance according to the displacement of the float disposed in the float chamber in such a manner as to be capable of displacement according to the height of the fuel surface. Therefore, the amount of remaining fuel can be stably indicated even when there are height fluctuations of the fuel surface due to vibrations or turning during running of the automobile.

According to the fourth aspect of the present invention, the fuel inlet window is provided in a lattice configuration. Therefore, the amount of remaining fuel can be stably indicated even when there are height fluctuations of the fuel surface due to vibrations or turning during running of the automobile.

According to the fifth aspect of the present invention, the float is provided with a plurality of through-holes. Therefore, the amount of remaining fuel can be stably indicated even when there are height fluctuations of the fuel surface due to vibrations or turning during running of the automobile.

According to the sixth aspect of the present invention, the float comprises an upper float member and a lower float member, and the sectional area of the lower float member is made larger than that of the upper float member. Therefore, the amount of remaining fuel can be stably indicated even when there are height fluctuations of the fuel surface due to vibrations or turning during running of the automobile. In addition, the amount of remaining fuel can be accurately indicated even when the fuel surface has lowered.

Still other objects and advantages of the invention will in part be obvious and will in part be apparent from the specification.

The invention accordingly comprises the features of construction, combinations of elements, and arrangement of parts which will be exemplified in the construction hereinafter set forth, and the scope of the invention will be indicated in the claims.

### BRIEF DESCRIPTION OF THE DRAWINGS

FIG. 1 is a front view of a fuel pump apparatus according to a first embodiment of the present invention.

FIG. 2 is a sectional view taken along the line I-I in FIG. 1, showing the fuel pump apparatus according to the first embodiment of the present invention.

FIG. 3 is a sectional view taken along the line II-II in FIG. 1, showing the fuel pump apparatus according to the first embodiment of the present invention.

FIG. 4A is a top plan view of a float of the fuel pump apparatus according to the first embodiment of the present invention.

FIG. 4B is a front view of the float shown in FIG. 4A.

FIG. 5 is a diagram showing the float performance comparison between the present invention and the prior art.

FIG. 6 is a front view of a fuel inlet window of a fuel pump apparatus according to a second embodiment of the present invention.

FIG. 7 is a front view of a fuel inlet window of a fuel pump apparatus according to a third embodiment of the present invention.

FIG. 8 is a perspective view of a float of a fuel pump apparatus according to a fourth embodiment of the present invention.

FIG. 9 is a sectional view of a fuel gauge of a fuel pump apparatus according to a fifth embodiment of the present invention.

FIG. 10 is a sectional view of a fuel gauge of a fuel pump apparatus according to a sixth embodiment of the present invention.

FIG. 11 is a sectional view of a fuel gauge of a fuel pump apparatus according to a seventh embodiment of the present invention.

### DESCRIPTION OF THE PREFERRED EMBODIMENTS

[First Embodiment]

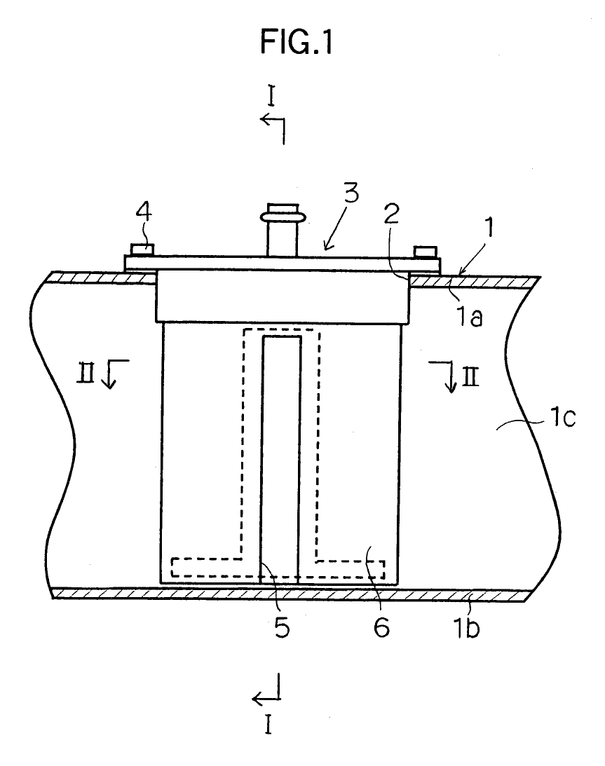

A first preferred embodiment of the present invention will be described below with reference to the accompanying drawings. As shown in FIG. 1, a fuel tank 1 is formed in a box-like shape by joining together an upper casing member 1a and a lower casing member 1b, which are produced from a steel or synthetic resin material. Thus, a fuel storage chamber 1c is formed in the fuel tank 1. The upper casing member 1a is provided with an opening 2. A fuel pump apparatus 3 is fitted into the opening 2 and hermetically secured to the upper casing member 1a with screws 4 or the like. A fuel inlet window 5 is provided in the side wall of a housing 6 (i.e. the side wall of a float chamber 11) in parallel to the axis of the housing 6.

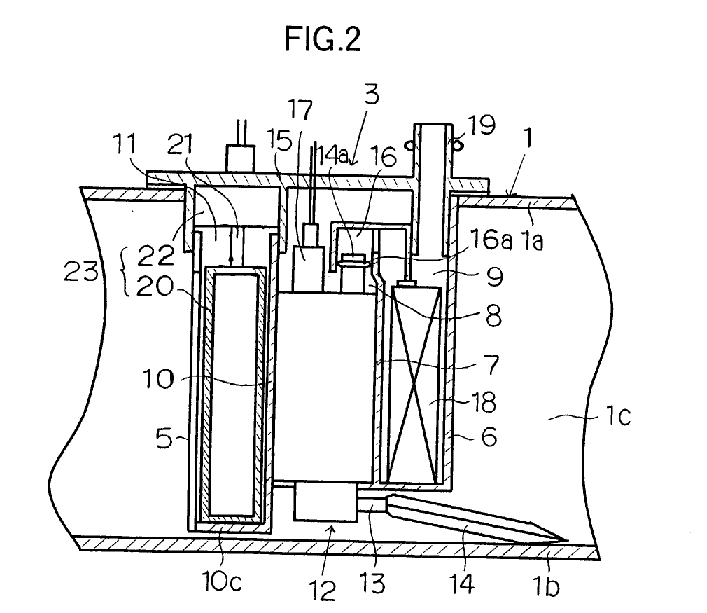

As shown in FIG. 2, the interior of the fuel pump apparatus 3 is divided into a fuel pump chamber 8 and a filter chamber 9 by a wall 7 provided in the housing 6. Further, the fuel pump chamber 8 is separated from a float chamber 11 by a wall 10. A fuel pump 12 is inserted into the fuel pump chamber 8. A motor (not shown) and a pump (not shown) are built in the fuel pump 12. The pump is driven by rotation of the motor to deliver high-pressure fuel.

A filter 14 is attached to a fuel suction opening 13 of the fuel pump 12 to prevent suction of dust, rust, etc. in the fuel. The distal end portion of the filter 14 is in contact with the bottom surface of the lower casing member 1b of the fuel tank 1. Further, the top of the fuel pump 12 is provided with a discharge pipe 14a for the fuel pressurized to high pressure by the pump. A passage 16 is formed by a wall portion integral with the wall 7. The passage 16 is kept hermetically sealed by the discharge pipe 14a and through an O-ring 16a. In addition, the top of the fuel pump 12 is provided with a terminal 17 for supplying electric power to the motor.

A filter 18 is inserted into the filter chamber 9 to further remove dust, rust and so forth from the fuel. A delivery pipe 19 is provided projecting from the top of a cover 15. The delivery pipe 19 is connected to an injector (not shown) attached to an engine (not shown).

A float 20 is inserted into the float chamber 11. The float 20 is limited in movement by a wall 10c so as to be slightly movable up and down. The float 20 has a hollow inside to increase the force of buoyancy acting thereon. A projection 21 is formed on the top of the float 20. A fuel level detecting element 22 is secured to the cover 15 at a position facing the projection 21. As the fuel level detecting element 22, for example, a piezoelectric element is usable.

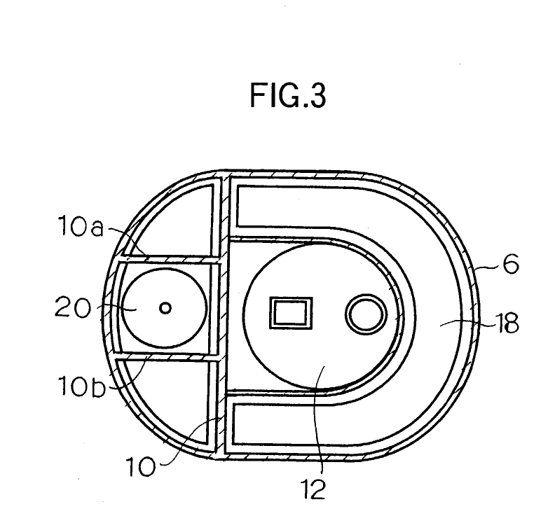

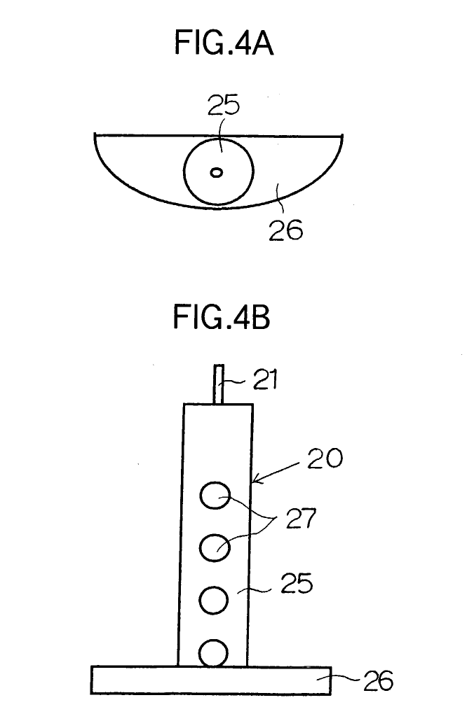

The float 20 and the fuel level detecting element 22 constitute in combination a fuel gauge 23. As shown in FIGS. 3, 4A and 4B, the float 20 comprises an upper float member 25 and a lower float member 26. The upper and lower float members 25 and 26 are limited in movement in the horizontal direction by the walls 10, 10a and 10b. As shown in FIG. 3, the filter 18 is inserted into the filter chamber 9 in the shape of a U. The float 20 is arranged as shown in FIGS. 4A and 4B. The upper float member 25 has a cylindrical configuration. The lower float member 26 is a thin plate-like member having a sectional configuration defined by a circular arc and a straight line segment. The upper float member 25 is provided with a plurality of communicating holes 27.

With the above-described arrangement, when the fuel level lowers as a result of the fuel in the fuel tank 1 being consumed by the engine during running of the automobile, the float 20 itself does not move down because the movement thereof is limited by the wall 10c, but the magnitude of buoyancy force acting on the float 20 reduces. The fuel level detecting element 22 converts a change in the buoyancy force into a corresponding change in voltage and outputs a voltage signal to the outside. Thus, the present fuel level is indicated by a fuel indicator (not shown) at the driver's seat. Meanwhile, there are height fluctuations of the fuel surface due to vibrations or turning during running of the automobile. However, waves occurring on the surface of fuel in the fuel storage chamber 1c are suppressed and damped in the float chamber 11 by the buffering action of the fuel inlet window 5. Therefore, height fluctuations of the fuel surface are minimized. Consequently, changes in the output voltage due to such height fluctuations of the fuel surface are also reduced. Thus, the adverse influence on the indication on the fuel indicator is minimized.

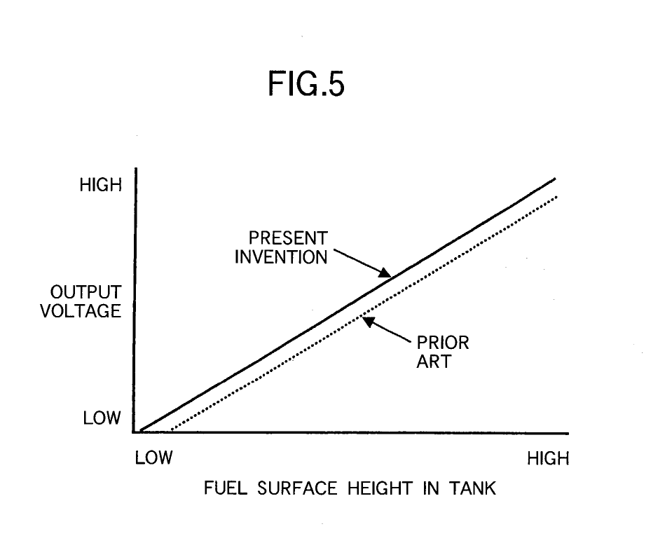

Further, because the lower float member 26 of the float 20 is increased in size, the float 20 in the present invention provides a greater buoyancy force than the conventional float for the same height of the fuel surface, as shown in FIG. 5. Hence, the float 20 allows a high output voltage to be obtained even at a low fuel level. Accordingly, even a small amount of fuel can be indicated accurately.

[Second Embodiment]

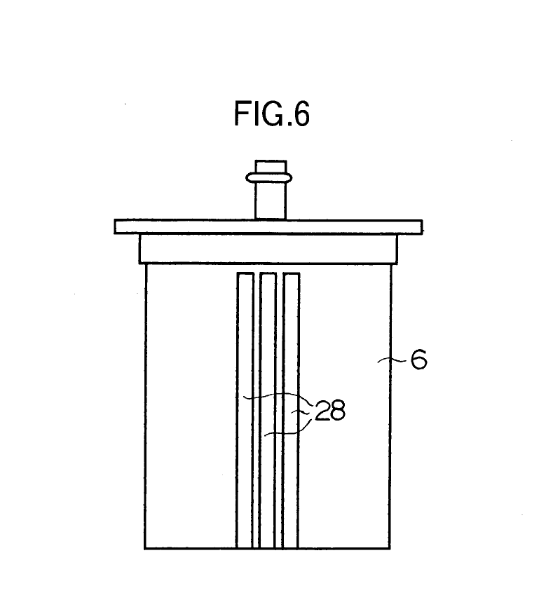

In the fuel pump apparatus shown in FIG. 1, the fuel inlet window 5 comprises a single vertically elongated window. However, the fuel inlet window in the present invention may comprise a plurality of fuel inlet windows 28 extending parallel to the axis of the housing 6 as shown in FIG. 6. With this arrangement, waves on the fuel surface can be damped even more effectively than in the first embodiment.

[Third Embodiment]

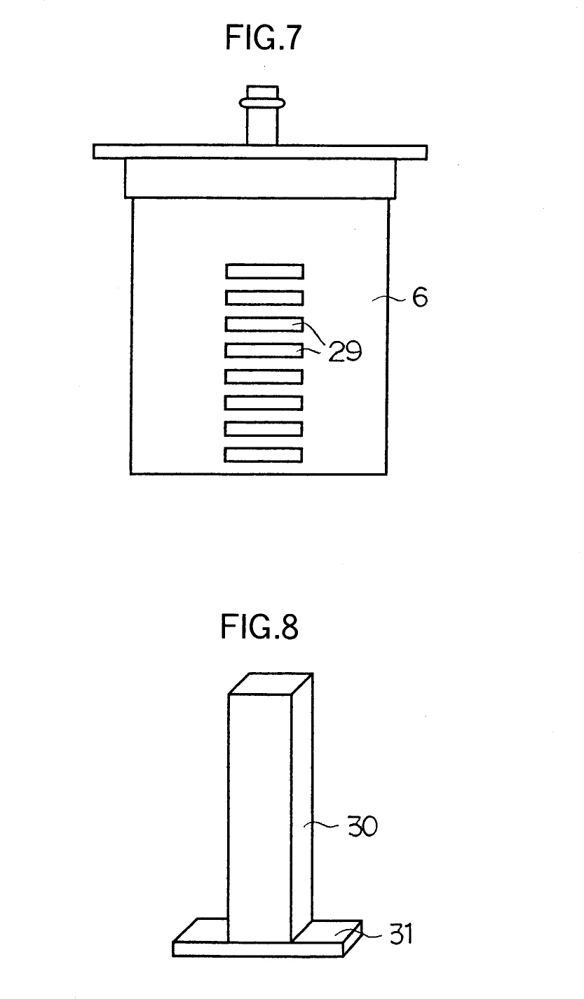

Although the fuel inlet window 5 in FIG. 1 comprises a single vertically elongated window, the fuel inlet window in the present invention may comprise a plurality of fuel inlet windows 29 extending perpendicularly to the axis of the housing 6 as shown in FIG. 7. With this arrangement, waves on the fuel surface can be damped even more effectively as in the case of the second embodiment.

[Fourth Embodiment]

The float 20 shown in FIGS. 4A and 4B has a circular cylinder-shaped configuration. However, as shown in FIG. 8, both the upper float member 30 and the lower float member 31 may have a rectangular parallelepiped configuration. This arrangement also offers advantageous effects similar to those obtained by the first embodiment.

[Fifth Embodiment]

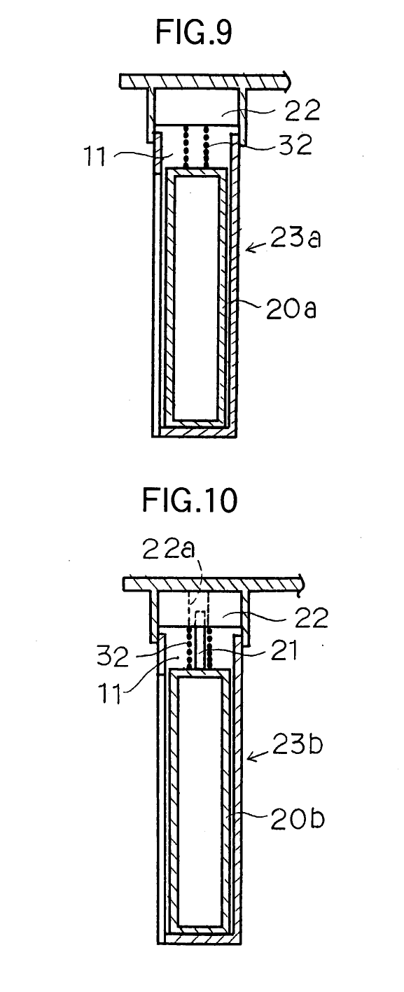

The fuel gauge 23 shown in FIG. 2 has the projection 21 on the top of the float 20 and uses a piezoelectric element as the fuel level detecting element 22. However, it is also possible to arrange a fuel gauge 23a, as shown in FIG. 9, in which a spring 32 is provided between a float 20a inserted in the float chamber 11 and a piezoelectric element 22 provided at the upper end of the float chamber 11, thereby urging the float 20a downward. This arrangement also offers advantageous effects similar to those obtained by the first embodiment.

[Sixth Embodiment]

The fuel gauge 23 may also be arranged as follows. That is, a fuel gauge 23b shown in FIG. 10 comprises a float 20b, a fuel level detecting element 22, and a spring 32. The float 20b is inserted into the float chamber 11 and has a projection 21 on the top thereof. The fuel level detecting element 22 has a through-hole 22a and is provided at the upper end of the float chamber 11. The spring 32 is provided between the float 20b and the fuel level detecting element 22. The projection 21 is inserted into the through-hole 22a of the fuel level detecting element 22. A resistor is used as the fuel level detecting element 22. The distal end (contact maker) of the projection 21 of the float 20b slides inside the resistor. The resistance changes according to the position of the contact maker. The change in the resistance is detected to detect a change in the fuel level. This arrangement also offers advantageous effects similar to those obtained by the first embodiment.

[Seventh Embodiment]

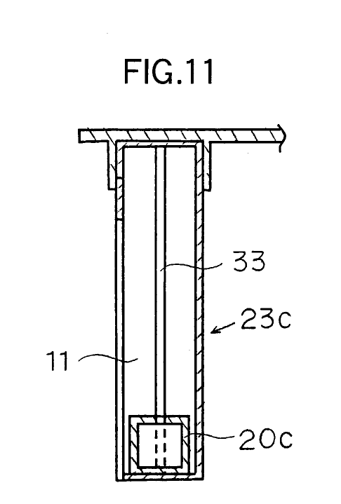

The fuel gauge 23 may also be arranged as shown in FIG. 11. A float 20c smaller in size than the float 20 is provided in the float chamber 11. An elongated resistor 33 is provided in the center of the float chamber 11 to extend vertically between the upper and lower ends of the float chamber 11 through the float 20c. The electric resistance (voltage) of the resistor 33 changes in response to the vertical movement of the float 20c according to a change in the buoyancy force acting on the float 20c. The change of the electric resistance (voltage) is taken out to detect a change in the fuel level. This arrangement also offers advantageous effects similar to those obtained by the first embodiment. It should be noted that although the floats 20, 20a, 20b and 20c in the foregoing description are hollow floats, they may be made of a closed-cell foamed material.

It should be noted that the present invention is not necessarily limited to the foregoing embodiments but can be modified in a variety of ways without departing from the gist of the present invention.

What is claimed is:

1. A fuel pump apparatus comprising:
a fuel pump installed in a fuel tank to supply fuel to an engine; and
a fuel gauge for detecting an amount of fuel remaining in said fuel tank, said fuel pump and fuel gauge being integrally incorporated in a housing;
wherein said fuel gauge is provided in a float chamber disposed inside a side wall of said housing, and a fuel inlet window is provided in a side wall of said float chamber to provide communication between said float chamber and a fuel storage chamber in said fuel tank.

2. A fuel pump apparatus according to claim 1, wherein said fuel gauge comprises:
a float substantially immovably disposed in said float chamber; and
a fuel level detecting element showing a change in voltage according to a magnitude of buoyancy force acting on said float.

3. A fuel pump apparatus according to claim 1, wherein said fuel gauge comprises:
a float disposed in said float chamber, said float being capable of displacement according to a height of a fuel surface; and
a fuel level detecting element showing a change in resistance according to displacement of said float.

4. A fuel pump apparatus according to claim 1 or 2, wherein said fuel inlet window is provided in a lattice configuration.

5. A fuel pump apparatus according to claim 1 or 2, wherein said float is provided with a plurality of through-holes.

6. A fuel pump apparatus according to claim 1 or 2, wherein said float comprises an upper float member and a lower float member, said lower float member having a larger sectional area than that of said upper float member.
